(19) United States
(12) Patent Application Publication
(10) Pub. No.: US 2008/0054024 A1
(43) Pub. Date: Mar. 6, 2008

(54) Material Pressure Feeding Apparatus And Material Pressure Feeding Method

(75) Inventor: Yoshimichi Kubota, Tokyo (JP)

Correspondence Address: LOWE HAUPTMAN HAM & BERNER, LLP, 1700 DIAGONAL ROAD, SUITE 300, ALEXANDRIA, VA, 22314, US

(73) Assignee: THREE BOND CO., LTD., Tokyo (JP)

(21) Appl. No.: 11/576,447

(22) PCT Filed: Oct. 4, 2005
(86) PCT No.: PCT/JP05/18324

§ 371 Date: Mar. 30, 2007

(30) Foreign Application Priority Data
Oct. 6, 2004 (JP) 2004-293260

(51) Int. Cl. B67D 5/42; G01F 11/00

(52) U.S. Cl. 222/386.5; 222/386; 222/405

(57) ABSTRACT

A material pressure feeding apparatus 10 includes a sack 11 containing material M having predetermined viscosity, a container 12 for holding the sack 11, a press member 13 disposed within the container 12 and positioned on the sack 11, a pressure feeder 15 having a suction port 37A for sucking the material M for lowering the press member 13 to pressurize the sack 11 containing the material M. The press member 13 includes a plate 21 having a plane-shape substantially identical to the opening 19 of the container 12, and a tubular member 22 along the inner peripheral side surface of the container 12, hanging vertically from the outer periphery of the plate 21 and forms a reception space 23. The press member 13 descends to reduce the volume of sack 11 forming wrinkled portion S and the wrinkled portion S is settled in the reception space 23.

### TECHNICAL FIELD

The present invention relates to a material pressure feeding apparatus and a material pressure feeding method, in particular to a material pressure feeding apparatus and a material pressure feeding method, which is capable of reducing the amount of the residual material after feeding material out of a container with pressure.

### BACKGROUND ART

Conventionally, resin materials of high viscosity such as silicone rubber and epoxy resin have been utilized as sealing materials. Such resin material contained in a predetermined container is arranged to be sucked and fed by pressure by required amount to a nozzle, from which the material is discharged onto a sealing surface and the like of a work.

FIG. 11 is a sectional view of the principal portion of a material pressure feeding apparatus showing a lower area thereof. Referring to FIG. 11, a material pressure feeding apparatus 50 includes a sack 51 for containing material M of high viscosity resin, a container 52 for receiving the sack 51, a press member 54 having a through hole 53 formed in the substantially central area thereof, which is disposed on the liquid surface of the material M in the sack 51, and a pressure feeder 57 having a suction port 56 communicating with the through hole 53 which is positioned on the press member 54. The upper area of the sack 51 is folded outwardly by the upper end of the container 52 to be supported by the container 52. The press member 54 includes a plate 59 having a substantially circular plate-like shape, in which the through hole 53 is formed, and an uprising portion 60 having a cylindrical shape continuously connected to the periphery of the plate 59. In such a structure, the material pressure feeding apparatus 50 is arranged so that, when the pressure feeder 57 is activated to lower the press member 54, the material M is sucked into the suction port 56 via the through hole 53.
Patent document 1: Japanese Patent Application Laid-open No. Hei 10-216607

### DISCLOSURE OF THE INVENTION

Problems to be solved by the Invention

In the material pressure feeding apparatus 50, however, as the press member 54 descends, the sack 51 is pulled down within the container 52. Therefore, the press member 54 generates wrinkles in the lower portion of the sack 51 containing the material M. As the press member 54 descends, the wrinkles are generated a lot not only in the side area but also in the bottom portion of the sack 51. As a result, the sack 51 wrinkled during the suction of the material M tends to block the suction port 56. Due to this, succeeding sucking of the material M becomes unsatisfactory or impossible, leading to that the material M tends to be left and also such a disadvantage arises that the sack 51 is broken due to the suction force from the suction port 56 and air bubbles are mixed in the material M.

Here, when the initial setting for the lower limit of the press member 54 is set to a higher position, the amount of the wrinkle generation can be reduced and thus the suction port 56 can be prevented from being blocked. In this case, however, such a reflective disadvantage that a lot of material M is left within the sack 51 is caused.

Further, the upper area of the sack 51 is kept opened and the material M is in the state to be exposed, and then the press member 54 is placed on the liquid surface. Therefore, the air is readily mingled in the material M from the interface between the press member 54 and the liquid surface, leading to such a disadvantage that a considerable amount of the material M has to be disposed at air purging. In particular, depending on the viscosity of the material M, since waves tend to be formed on the liquid surface, a larger amount of air is mingled in the material M, resulting in the disadvantage of significant amount of material disposition.

Moreover, the lower face of the press member 54 comes into contact with the material M. Therefore, when the press member 54 is reused at each occasion of replacement of the sack 51, it is inevitable to carry out such a troublesome work to remove the material M adhered on the press member 54. Further, while carrying out the removal work of the adhered material M or folding back the upper end of the sack 51, there can be such a disadvantage that the material M accidentally adheres to hands, container 52 and/or other equipment causing a dirt or damage.

### OBJECT OF THE INVENTION

The present invention has been proposed in view of the above disadvantages. An object of the present invention is to provide a material pressure feeding apparatus and a material pressure feeding method capable of reducing the residual material in the container as small as possible after feeding out the material in the container with pressure thereon.

Another object of the present invention is to provide a material pressure feeding apparatus and a material pressure feeding method capable of preventing the air mingling to the material.

Further another object of the present invention is to provide a material pressure feeding apparatus and a material pressure feeding method capable of preventing unintended adhesion of the material to reduce the maintenance work and the like.

Means to Solve the Problems

In order to achieve the above object, the present invention employs a material pressure feeding apparatus, which includes:

a sack containing a material with a predetermined viscosity;

a container for containing the sack formed with an opening in its upper portion;

a press member disposed within the container and positioned on the sack; and

a pressure feeder for lowering the press member to pressurize the sack containing the material, and having a suction port for sucking the material by lowering the press member, wherein

the press member is arranged to descend and reduce the capacity of the sack so as to form a wrinkled portion, and to form a reception space for receiving the wrinkled portion in the lower portion thereof.

The present invention preferably employs such arrangement that the press member includes a plate, which has a plane shape substantially identical to that of the opening of the container, and a tubular member, which is positioned along the inner peripheral side surface of the container, hanging down vertically from the outer peripheral side of the plate to form the reception space therein.

Also, the plate may employ such arrangement that the plate includes a through hole communicating with the suction port in the central area of the plane, along which the sack can be cut off.

Further, it is preferred to employ such arrangement that a spacer is provided between the bottom portion of the container and the bottom outer surface of the sack so as to be received inside the above mentioned reception space.

Further, the spacer may employ such arrangement that, when the spacer is received inside the reception space, the spacer forms a space for containing the wrinkled portion of the sack within the reception space.

The method of the present invention employs such a material pressure feeding method, in which a sack containing a material having a predetermined viscosity; a container for holding the sack in an upper portion of which an opening is formed; a press member disposed within the container and positioned on the sack; and a pressure feeder for lowering the press member to pressurize the sack containing the material, are included and a material is sucked from a suction port in the pressure feeder by lowering the press member, wherein

the press member includes: a plate having a plane shape substantially identical to that of the opening of the container; a tubular member positioned along the inner peripheral side surface of the container and hanging down vertically from the outer peripheral side of the plate to form a reception space; and a through hole formed within a plane of the plate and communicating with the suction port; wherein

the plate is placed on the sack so that the sack is positioned within a reception space of the press member, thereafter forming a hole by cutting off the sack along the periphery of the through hole, and succeedingly

the press member is lowered by means of the pressure feeder causing the material in the sack to pass through the hole and the through hole to suck the material via the suction port, and a wrinkled portion of the sack formed by reducing the volume of the sack is received in the reception space.

### EFFECTS OF THE INVENTION

According to the present invention, the wrinkled portion formed on the sack is received in a reception space of the press member. Therefore, it is possible to restrain forming of wrinkled portion in an unspecified position such as the bottom portion of the sack; and thus, also possible to prevent the suction port being blocked by the wrinkled portion. Owing to this, even when the lowest position of the press member is set to a lower position, the suction port can be prevented from being blocked by the wrinkled portion. Air mingling to the material due to sack breakage, which is a conventional problem, is prevented and the amount of the residual material within the sack after feeding out the material with pressure can be reduced.

Also, the press member is arranged so as to use the plate and the tubular member, which is formed being connected to the plate hanging down along the inner peripheral side surface of the container. Accordingly, the reception space can be formed in the press member with a simple arrangement. Further, while the press member descends, the lower end of the tubular member enters between the inner peripheral side surface of the container and the peripheral surface of the sack. Accordingly, at a position along the tubular member in the reception space, the wrinkled portion is continuously formed and received efficiently.

Furthermore, if the sack is arranged so as to be cut off along the through hole of the plate in a state that the sack is closed and the press member is placed thereon, a hole can be formed by cutting off the sack. The hole allows the through hole and the inside of the sack to communicate with each other. Thereby, the lower face of the plate can be maintained in a substantially non-contact state with the material and thus the material can be almost kept away from adhering to the plate. Owing to this, in the case where the press member is reused at the occasion of the sack replacement, cleaning work to remove the material from the press member can be eliminated resulting in a reduced maintenance work and the like. And further, air mingling to the material through the interface between the plate and material liquid surface, which is a conventional problem, is restrained and the amount of the waste material at air purging can be reduced.

Still further, in the case where the spacer which is arranged to be receivable inside the reception space is provided, the spacer can reduce the space for the material to remain in the reception space when the press member descents, and thereby the amount of the residual material in the container can be reduced.

Still furthermore, the spacer forms a space for settling the wrinkled portion of the sack in the reception space, in other words the spacer and the wrinkled portion can be contained concurrently in the reception space. Accordingly, the amount of the residual material can be further reduced.

### BRIEF DESCRIPTION OF DRAWINGS

FIG. 1 is a front sectional view of a principal portion of a material pressure feeding apparatus in accordance with an embodiment of the present invention.

FIG. 2 is a sectional view of the same in FIG. 1 showing a state immediately before a sack is inserted into a container.

FIG. 3 is a sectional view of the same in FIG. 1 showing a state immediately before a press member is installed in the container.

FIG. 4 is a schematic perspective view of the press member.

FIG. 5 is a partially enlarged sectional front view of the press member.

FIG. 6 is schematic perspective view of a spacer.

FIG. 7 is a perspective view schematically showing a projecting member.

FIG. 8 is a sectional view of the same in FIG. 1 showing a state immediately before the pressure feeder is set up.

FIG. 9 is a sectional view showing a state that the material has been completely fed out with pressure from the state shown in FIG. 1.

FIG. 10 is an enlarged sectional view of a principal portion of the press member and the periphery area thereof while the press member is descending.

FIG. 11 is a front sectional view of a principal portion of a material pressure feeding apparatus in accordance with a conventional example.

### DESCRIPTION OF REFERENCE NUMERALS

10 material pressure feeding apparatus
11 sack
12 container
13 press member
14 spacer
15 pressure feeder
18 bottom wall portion (bottom portion)
19 opening
21 plate
22 tubular member
23 reception space
25 through hole
30 space
37A suction port
46 hole
M material
S wrinkled portion

### BEST MODE FOR CARRYING OUT THE INVENTION

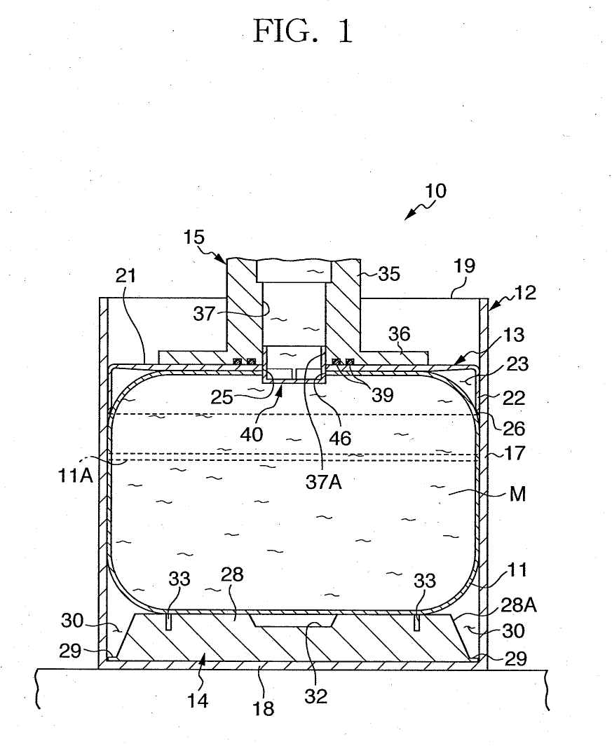

Hereinafter, an embodiment of the present invention will be described with reference to the drawings. In this specification, the wordings “upper” and “lower” are used with reference to FIG. 1, unless otherwise specified.

FIG. 1 shows a front sectional view of a principal portion of a material pressure feeding apparatus in accordance with the embodiment. Referring to FIG. 1, the material pressure feeding apparatus 10 comprises a sack 11 in which a material M of a high viscosity resin such as silicone is contained, a container 12 for receiving the sack 11, a press member 13, which is provided in the container 12 and positioned on the sack 11, a spacer 14 provided at the bottom of the container 12 and a pressure feeder 15 provided above the press member 13.

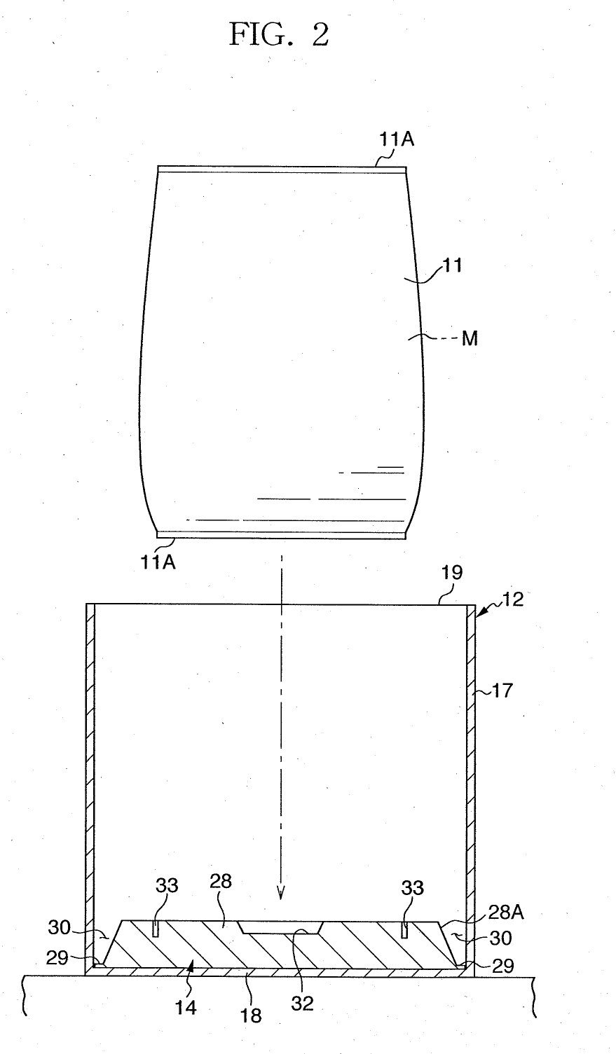

The sack 11 is formed of a resin film such as polyethylene. As shown in FIG. 2, the sack 11 is arranged so that the upper and lower ends thereof are formed as the thermally bonded areas 11A to maintain the inside thereof in a substantially vacuum state.

The container 12 is formed of a metal such as stainless steel or a hard resin such as polypropylene capable of maintaining a given shape. The container 12 is formed as a container with bottom, which has a peripheral wall 17 having a substantially cylindrical shape oriented in the vertical direction, and a bottom wall portion 18 as the bottom continuously formed with the lower portion of the peripheral wall 17; and the an opening 19 is formed in the upper portion thereof.

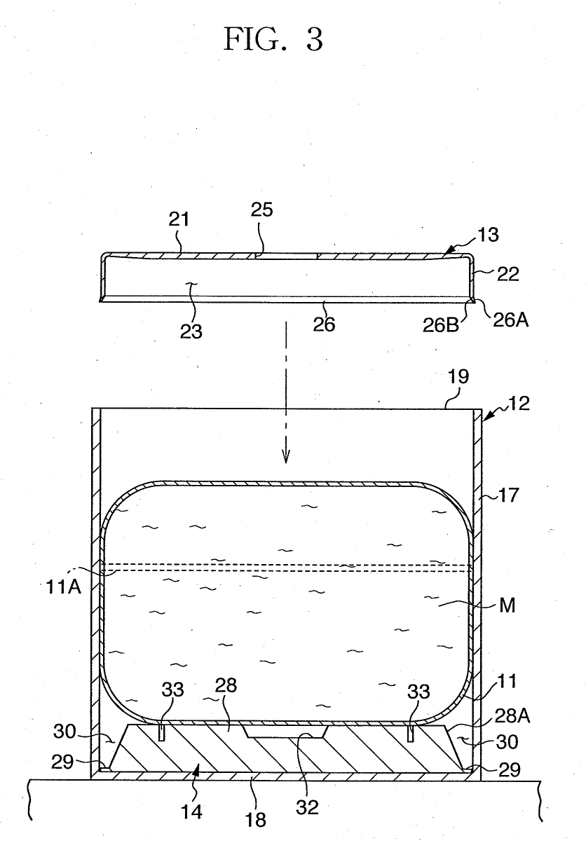

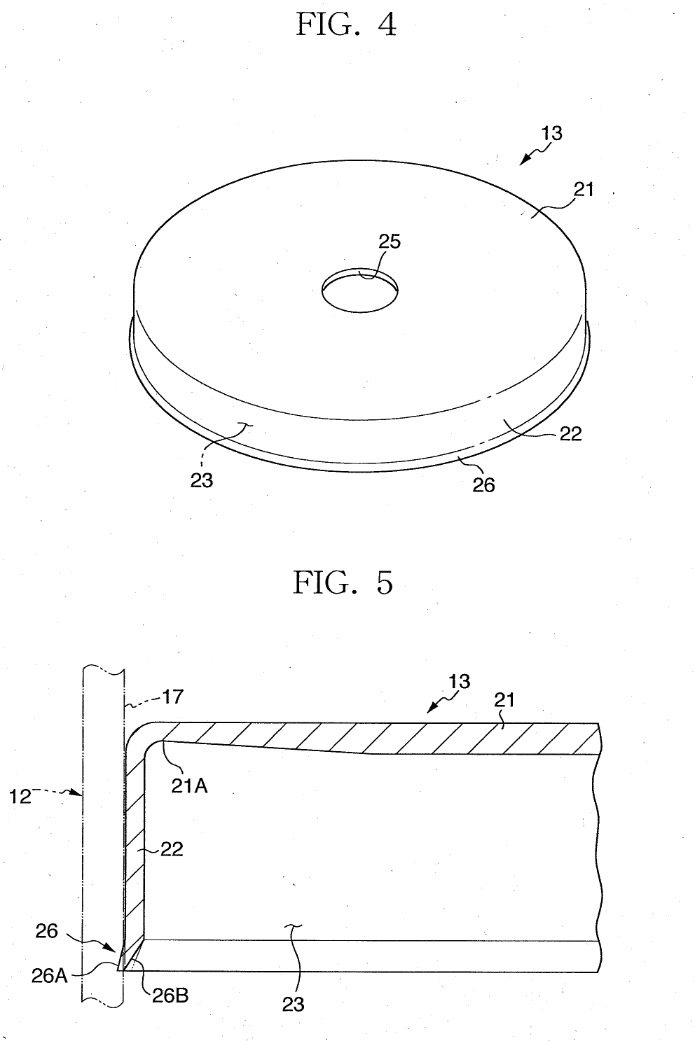

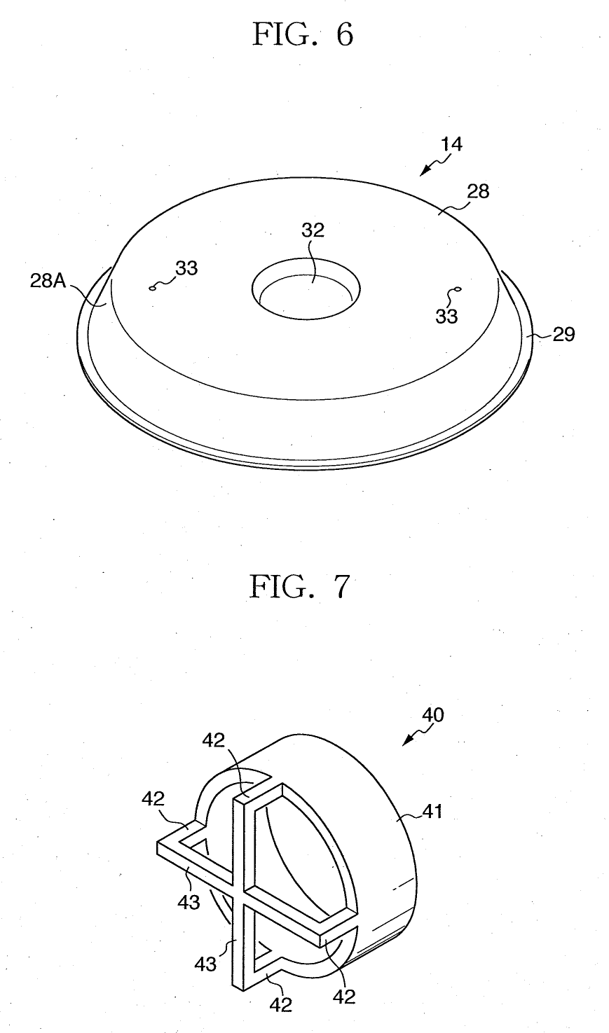

As shown in FIG. 1, FIG. 3 and FIG. 4, the press member 13 includes a plate 21, which is formed in substantially the same plane shape as that of the opening 19; i.e., a substantially circular shape, and a tubular member 22, which is positioned connecting with the outer peripheral side of the plate 21 and hanging down along the inner peripheral side surface of the peripheral wall 17, and in lower surface side of the plate 21, a reception space 23 is formed inside the tubular member 22 which is opened downwardly. In the central area of the plane of the plate 21, a substantially circular through hole 25 is formed. As shown in FIG. 5, the outer area of the plate 21 is formed so as to be gradually thinner in thickness toward the outer portion (left side in FIG. 5). And the thickness of the outer end portion 21A of the plate 21 is arranged so as to be substantially the same as the thickness of the tubular member 22. At the lower end side of the tubular member 22, a tapered portion 26 is continuously formed being oriented to the lower outer direction. The tapered portion 26 is formed so as to be gradually thinner downward, and the both faces thereof are formed as sloped faces 26A and 26B. The tapered portion 26 is arranged, when the press member 13 is inserted into the container 12, so as to deform flexibly toward the inside to abut against the inner peripheral side surface of the peripheral wall 17.

As shown in FIG. 1, the spacer 14 is disposed between the bottom wall portion 18 of the container 12 and the bottom outer surface of the sack 11. As shown in FIG. 6 as well, the spacer 14 includes a spacer body 28, which has a substantially frustum shape with a sloped face 28A on its periphery, and a flange portion 29, which is continuously formed outwardly on the lower periphery of the spacer body 28. The flange portion 29 is formed so that the peripheral portion of the flange has substantially the same peripheral shape as that of the bottom wall portion 18, and a space 30 is provided between the sloped face 28A and the peripheral wall 17. In the central area in the upper face of the spacer body 28, a hollowed portion 32 is provided enabling to receive a projecting member, which will be described later. Bolt-mounting holes 33 are formed at two points along the radial direction of the spacer body 28 on the upper face thereof. Bolts, not shown though, can be screwed into the bolt mounting holes 33 so that the spacer 14 can be inserted into or pulled out from the container 12. Note that, although the spacer 14 is solid and has a disk-like shape in this embodiment, the spacer may be hollow having the same outer shape.

As shown in FIG. 1, the pressure feeder 15 includes a main tube 35 having a substantially cylindrical shape, and a flange portion 36, which is formed outwardly at the lower-bottom side of the outer periphery of the main tube 35 and has a smaller diameter than that of the plate 21. The pressure feeder 15 is arranged so as to move vertically by means of a lifter not shown. In the main tube 35 is provided a path 37 passing through in the vertical direction, and a suction port 37A at the lower end of the path 37 is arranged to communicate with the through hole 25 on the substantially same axis. O-rings 39 are provided outside the suction port 37A to prevent the material M from leaking through the connecting portion between the through hole 25 and the path 37. At the suction port 37A side of the path 37, a projecting member 40 is inserted and fixed thereto.

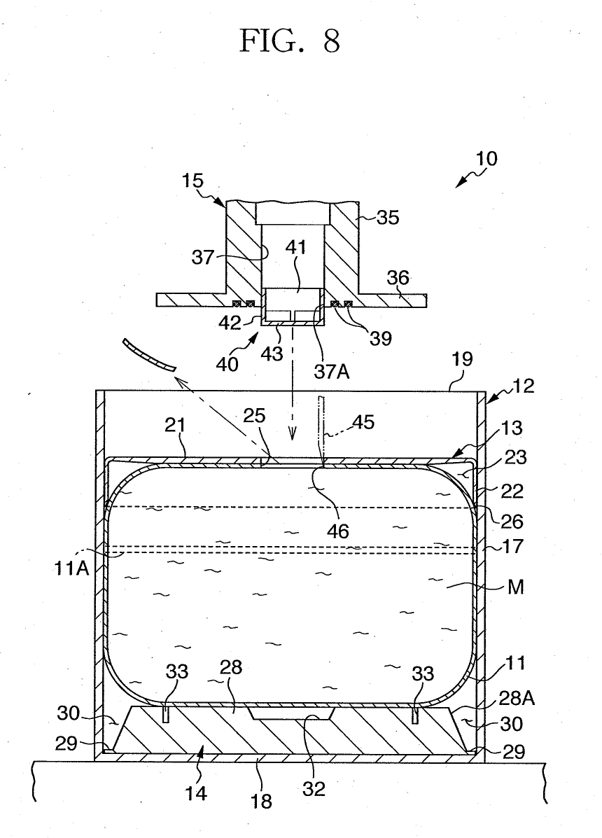

As shown in FIG. 7 and FIG. 8, the projecting member 40 is arranged to have such a configuration that includes: a tubular portion 41, which is inserted into the path 37 along the inner peripheral side surface thereof and fixed thereto; four protruding portions 42, which are, in one end face of the tubular portion 41, protruded at substantially 90° intervals along the peripheral direction of the tubular portion 41; and two connecting portions 43, which connect the opposing protruding portions 42 with each other in the radial direction of the tubular portion 41. The projecting member 40 is arranged be disposed so that, in a mounted state as shown in FIG. 1, the protruding portion 42 and the connecting portions 43 protrude downward from the suction port 37A, and protrude further a predetermined length further downward through the through hole 25.

Next, suction and pressure feeding steps for the material M by the material pressure feeding apparatus 10 will be described.

First of all, as a preparation for carrying out suction of the material M, as shown in FIG. 2, the spacer 14 is placed on the bottom wall portion 18 of the container 12. And then, the sack 11 maintained in a substantially vacuum state is placed within the container 12. The thermally bonded area 11A at the upper end side of the sack 11 is positioned along the peripheral wall 17 of the container 12, adjusting so that no wrinkle is formed in the upper face of the sack 11 through rotating insertion. Then, as shown in FIG. 3, the press member 13 is placed so as to receive the upper portion of the sack 11 in the reception space 23. Subsequently, as shown in FIG. 8, a hole 46 having a substantially same shape as that of the through hole 25 is formed in the sack 11 by moving a cutter blade 45 and the like along the inner periphery of the through hole 25 in the press member 13. And then, as shown in FIG. 1, the pressure feeder 15 is placed on the plate 21 of the press member 13 so that the projecting member 40 provided in the suction port 37A is inserted into the through hole 25 and the hole 46.

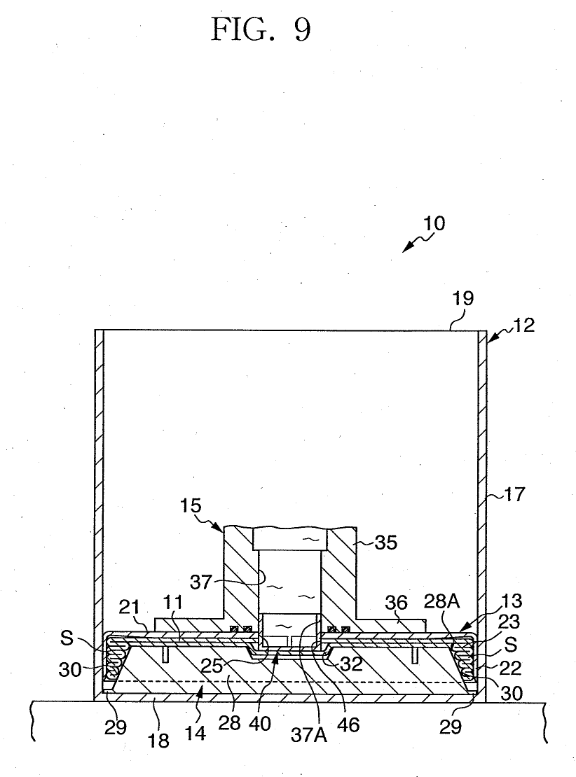

In this state, the pressure feeder 15 lowers the press member 13 by operation of the lift (not shown). Owing to this, the press member 13 pressurizes the sack 11 containing the material M, and the dimension of the sack 11 is reduced leading to inner pressure increase of the material M. Thus, the material M is sucked via the suction port 37A through the through hole 25 and the hole 46, and the material M is fed by pressure to an operation nozzle not shown through the path 37. As shown in FIG. 9, when the press member 13 comes closer to the bottom wall portion 18 of the container 12, the spacer body 28 of the spacer 14 is received in the reception space 23, the material M remaining inside the reception space 23 is also sucked through the suction port 37A. Here, the lower portion of the projecting member 40 comes into contact with the inner surface of the bottom of the sack 11 and is received in the hollowed portion 32. Further, owing to the suction force by the suction port 37A, the bottom of the sack 11 comes into contact with the connecting portion 43 of the projecting member 40, the material M is sucked and fed by pressure through the spaces between the protruding portions 42.

Here, the state of the sack 11 when the press member 13 is lowered will be described further in detail.

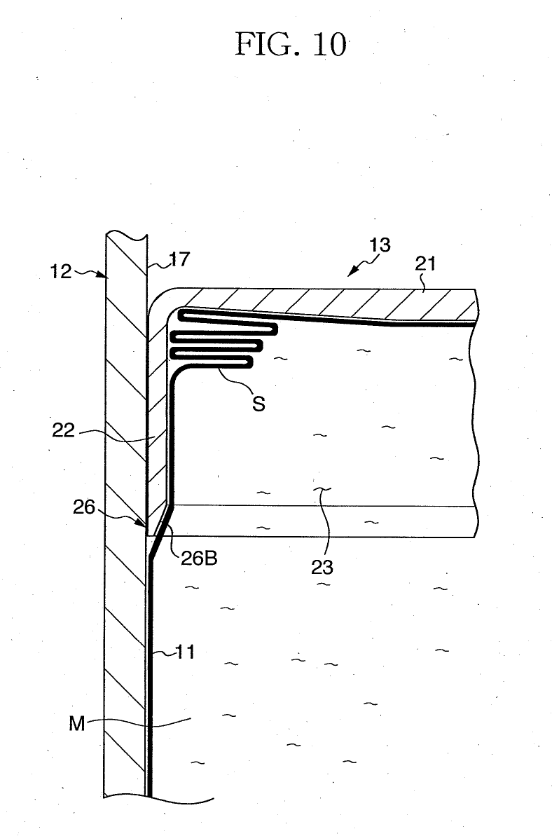

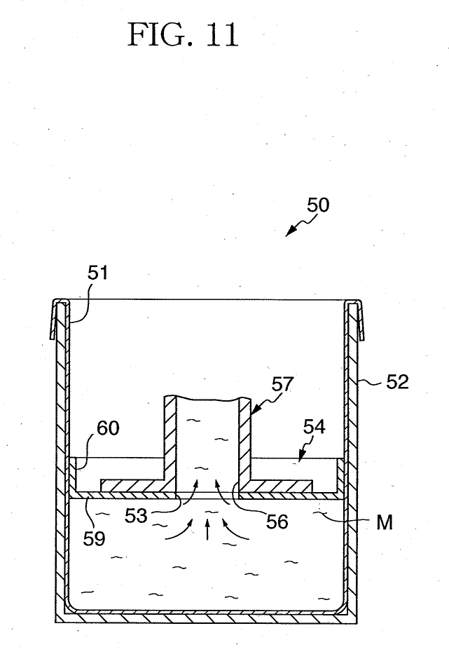

Accompanying the volumetric reduction of the sack 11, as shown in FIG. 10, a wrinkled portion S is formed in the sack 11. That is, as the press member 13 is lowered, the tubular member 22 enters between the inner surface of the peripheral wall 17 of the container 12 and the outer surface of the sack 11. And the upper portion of the side area (area along the inner surface of the peripheral wall 17) of the sack 11 is received in the reception space 23 along the inner surface of the tubular member 22. When the press member 13 is further lowered, the upper portion of the side area of the sack 11 is continuously folded in a position along the inner surface of the tubular member 22 in the reception space 23; thus the wrinkled portion S is formed. Consequently, when the spacer body 28 is received in the reception space 23, as shown in FIG. 10, the tubular member 22 and the wrinkled portion S are settled in the space 30. Thus, the lower face of the plate 21 and the upper face of the spacer body 28 come closer to each other sandwiching the sack 11 therebetween.

Therefore, according to the above embodiment, since the wrinkled portion S is formed in a position within the reception space 23 along the tubular member 22, the wrinkled portion S is settled in a position away from the suction port 37A sufficiently enough, enabling to prevent blockage of the suction port 37A by the wrinkled portion S. Moreover, since the space 30 is formed so that the wrinkled portion S and the spacer body 28 are settled concurrently within the reception space 23, the lowest position of the press member 13 can be set to a position where the upper face of the spacer body 28 comes closer to the lower face of the plate 21. Accordingly, the residual material M in the reception space 23 can be reduced; thus, the material can be used to its end as much as possible.

Also, in the upper portion of the sack 11, the hole 46 can be formed in a substantially same shape as that of the opening of the through hole 25, therefore due to the sack 11, substantially non-contact state of the lower face of the plate 21 with respect to the material M is realized. Owing to this, the material adhesion to the plate 21 is prevented, which can eliminate washing work and the like of the press member 13 at the occasion of the sack 11 replacement, which likely causes dropping material M and so on, thereby enabling to improve the working environment. Furthermore, compared to the conventional type, the area that the material M comes into contact with the air is made smaller. Thus, the air is prevented from mingling to the material M and the amount of the waste material M, which has to be disposed of at air purging can be reduced.

Furthermore, a tapered portion 26 is formed at the lower end side of the tubular member 22. Accordingly, the tubular member 22 easily enters between the outer surface of the sack 11 and the inner peripheral side surface of the peripheral wall 17; thus, the press member 13 can be lowered smoothly. To be more specifically, the sloped face 26B inside the tapered portion 26 serves as a guide. That is, owing to the sloped face 26B, the side-upper end of the sack 11 is oriented to the direction so as to enter into the reception space 23. Owing to this, the sack 11 is received in the reception space 23 in order to form the wrinkled portion S.

Still further, when the press member 13 descends, since the central area in the plane of the plate 21 is depressed by the flange portion 36 of the pressure feeder 15. Accordingly, the central area of the plate 21 is flexibly deformed in a concave shape; and owing to the flexible deformation, the lower portion of the tubular member 22 is enlarged outward. Owing to this, the contact force between the lower portion and the tapered portion 26 of the tubular member 22 and the inner peripheral side surface of the peripheral wall 17 can be increased, and thereby, the tubular member 22 can enter more easily between the outer surface of the sack 11 and the inner peripheral side surface of the peripheral wall 17.

The best arrangement and so on for carrying out the present invention have been disclosed so far. However, the present invention is not limited to the above.

That is, the present invention has been specifically illustrated and described with respect to a particular embodiment. It is possible for a person skilled in the art to add various modifications to the above-described embodiment in shape, number and other detailed arrangement without departing from the scope of the technical spirit and the object of the present invention. Therefore, the above-disclosed arrangement has been given just an example for the purpose to facilitate understanding of the present invention, not to limit the present invention. Therefore, the descriptions using appellations of component members disregarding all or a part of the limitations such as the shape and the like are to be included in the present invention.

For example, the press member 13 may be variously modified as far as the reception space for receiving the wrinkled portions is included. However, in order to obtain the above working and effect satisfactorily, such arrangement as the above-described embodiment is preferably employed.

In this embodiment, the projecting member 40 is provided at the suction port 37A and a hollowed portion 32 is formed in the upper face of the spacer 14. However, such arrangement without these may be employed.

Further, the sack 11 may be contained without disposing the spacer 14 in the container 12. However, it is advantageous to dispose the spacer 14 to reduce the amount of the residual material M.

Furthermore, the shape of the opening 19 of the container 12 may be modified to a substantially quadrangle, a substantially polygonal shape, a substantially elliptical shape or the like; and the plane shape of the plate 21 of the press member 13 may be changed so as to be substantially identical thereto.

1. A material pressure feeding apparatus, comprising:
a sack containing a material having a predetermined viscosity;
a container for containing the sack, having an opening formed in the upper portion thereof;
a press member provided within the container and positioned on said sack; and
a pressure feeder for lowering the press member to press the sack containing the material, and having a suction port for sucking the material by said lowering press member, wherein
said press member is arranged to reduce the volume of the sack by said lowering so as to form a wrinkled portion, and a reception space is formed for receiving the wrinkled portion in the lower portion thereof.

2. The material pressure feeding apparatus according to claim 1, wherein said press member includes a plate, which has a plane shape substantially identical to that of the opening of the container, and a tubular member, which is positioned along the inner peripheral side surface of the container, hanging down vertically from the outer peripheral side of the plate to form said reception space.

3. The material pressure feeding apparatus according to claim 2, wherein said plate is provided with a through hole communicating with said suction port in the central area of the plane and is arranged so that the sack can be cut off along the periphery of the through hole.

4. The material pressure feeding apparatus according to claim 1, wherein a spacer is provided between the bottom face of said container and the outer bottom surface of the sack, the spacer being arranged so as to be received inside the reception space.

5. The material pressure feeding apparatus according to claim 4, wherein, when said spacer is received inside the reception space, said spacer forms a space for settling the wrinkled portion of the sack within the reception space.

6. A material pressure feeding method, in which a sack containing a material having a predetermined viscosity; a container for containing the sack in an upper portion of which an opening is formed; a press member disposed within the container and positioned on said sack; and a pressure feeder for lowering the press member to pressurize the sack containing the material, are included and a material is sucked from a suction port in the pressure feeder by lowering said press member, wherein
said press member includes: a plate having a plane shape substantially identical to that of the opening of the container; a tubular member positioned along the inner peripheral side surface of the container and hanging down vertically from the outer peripheral side of the plate to form a reception space; and a through hole formed within a plane of the plate and communicating with the suction port; wherein
the plate is placed on the sack so that the sack is positioned within a reception space of said press member, thereafter forming a hole by cutting off the sack along the periphery of the through hole, and succeedingly
the press member is lowered by means of the pressure feeder causing the material in the sack to pass through said hole and the through hole to suck the material via the suction port, and a wrinkled portion of the sack formed by reducing the volume of the sack is received in said reception space.
